(19) United States
(12) Patent Application Publication
(10) Pub. No.: US 2022/0289953 A1
(43) Pub. Date: Sep. 15, 2022

(54) ROTOMOLDED PARTS PREPARED FROM BIMODAL POLYETHYLENE

(71) Applicant: NOVA Chemicals (International) S.A., Fribourg (CH)

(72) Inventors: Celine Bellehumeur, Calgary (CA); Douglas Checknita, Calgary (CA); Henry Hay, Calgary (CA); Derek Wasylenko, Calgary (CA); Tony Tikuisis, Calgary (CA)

(73) Assignee: NOVA Chemicals (International) S.A., Fribourg (CH)

(21) Appl. No.: 17/629,138

(22) PCT Filed: Jul. 2, 2020
(86) PCT No.: PCT/IB2020/056268

§ 371 Date: Jan. 21, 2022

Related U.S. Application Data
(60) Provisional application No. 62/878,388, filed on Jul. 25, 2019.

(51) Int. Cl. C08L 23/06; C08L 23/08; B29C 41/04; B29C 41/00

(52) U.S. Cl. CPC C08L 23/06; C08L 23/08; B29C 41/04; B29C 41/003; B29K 2023/06; B29K 2023/08

(57) ABSTRACT

A dual reactor solution process gives high density polyethylene compositions containing a first ethylene copolymer and a second ethylene copolymer and which have good processability, toughness, and environmental stress crack resistance. The polyethylene compositions are suitable for the preparation of rotomolded parts.

### TECHNICAL FIELD

This disclosure relates to polyethylene compositions that are useful in the manufacture of rotomolded articles such as custom parts, sporting goods, insulated containers and multilayers parts.

### BACKGROUND ART

Polyethylene blends produced with conventional Ziegler-Natta or Phillips type catalysts systems can be made having suitably high density and ESCR properties, see for example, WO 00/71615 and U.S. Pat. No. 5,981,664. However, the use of conventional catalyst systems typically produces significant amounts of low molecular weight polymer chains having high comonomer contents, which results in resins having lower toughness and limiting the range of applications.

In contrast to traditional catalysts, the use of so-called single site catalysts (such as “metallocene” and “constrained geometry” catalysts) provides resin having lower catalyst residues and improved organoleptic properties as suggested by U.S. Pat. No. 6,806,338. The disclosed resins are suitable for use in molded articles. Further resins comprising metallocene catalyzed components and which are useful for molding applications are described in U.S. Pat. Nos. 7,022,770; 7,307,126; 7,396,878 and 7,396,881 and 7,700,708.

U.S. Patent Appl. No. 2011/0165357A1 suggests a blend of metallocene catalyzed resins which is suitable for use in pressure resistant pipe applications.

U.S. Patent Appl. No. 2006/0241256A1 suggests blends formulated from polyethylenes made using a hafnocene catalyst in the slurry phase.

A bimodal resin having a relatively narrow molecular weight distribution and long chain branching is described in U.S. Pat. No. 7,868,106. The resin is made using a bis-indenyl type metallocene catalyst in a dual slurry loop polymerization process and can be used to manufacture caps and closures.

U.S. Pat. No. 6,642,313 suggests multimodal polyethylene resins which are suitable for use in the manufacture of pipes. A dual reactor solution process is used to prepare the resins in the presence of a phosphinimine catalyst. Narrow molecular weight polyethylene blends comprising a metallocene produced polyethylene component and a Zielger-Natta or metallocene produced polyethylene component are reported in U.S. Pat. No. 7,250,474. The blends can be used in molding and rotomolding applications such as for example, water containers, playground equipment and sporting goods.

### SUMMARY OF INVENTION

In an embodiment, there is provided a rotomolded part made from a bimodal polyethylene composition comprising

(1) 10 to 70 wt % of a first ethylene copolymer having a melt index, I₂, of less than 1.0 g/10 min; a molecular weight distribution, M_{w}/Mₙ, of less than 3.0; and a density of from 0.920 to 0.955 g/cm³; and

(2) 90 to 30 wt % of a second ethylene copolymer having a melt index I₂, of from 100 to 20,000 g/10 min; a molecular weight distribution, M_{w}/Mₙ, of less than 3.0; and a density higher than the density of the first ethylene copolymer, but less than 0.967 g/cm³;

wherein the density of the second ethylene copolymer is less than 0.037 g/cm³ higher than the density of the first ethylene copolymer; the ratio of short chain branching in the first ethylene copolymer (SCB1) to the short chain branching in the second ethylene copolymer (SCB2) is greater than 0.5; and wherein the bimodal polyethylene composition has a molecular weight distribution, M_{w}/Mₙ, of from 3 to 11; a density of at least 0.949 g/cm³; a melt index I₂, of from 0.4 to 12 g/10 min; a Z average molecular weight M_{z} of less than 400,000; a stress exponent of less than 1.50; and a relative elasticity defined as the ratio of G′/G″ at frequency of 0.05 rad/s, less than 1.3.

### BRIEF DESCRIPTION OF DRAWINGS

FIG. 1 shows the relationship between the shear thinning index SHI_{(1,100)} and the melt index, I₂ of some polyethylene compositions according to this disclosure.

FIG. 2 shows the molecular weight distribution from GPC measurements.

FIG. 3 shows the molecular weight distribution and comonomer distribution from GPC-FTIR measurement for example 3.

FIG. 4 shows molecular weight distribution and comonomer distribution from GPC-FTIR measurement for example 4.

FIG. 5 shows the complex viscosity profiles versus complex modulus from DMA frequency sweep carried out at 190° C. for examples 1, 2, 3, 4, 6 and 7.

FIG. 6 shows the storage modulus (G′) and loss modulus (G″) profiles from DMA frequency sweep carried out at 190° C. for examples 3 and 4.

FIG. 7 shows a Cole-Cole plot from DMA frequency sweep carried out at 190° C. for examples 3 and 4.

FIG. 8 shows the density on rotomolded specimens (density as-is). Specimens collected from 6.35 mm thick test cube parts molded using an oven temperature of 293° C., varying the oven residence time.

FIG. 9 shows the difference between as-is and nominal density. For as-is density, specimens were collected from 6.35 mm thick test cube parts molded using an oven temperature of 293° C., varying the oven residence time. Nominal density determined according to ASTM D792.

FIG. 10 shows an optical microscopy photograph of the cross section of a specimen taken from a rotomolded part made using the composition of example 8 at 16 minutes oven time when the part is undercooked.

FIG. 11 shows an optical microscopy photograph of the cross section of a specimen taken from a rotomolded part made using the composition of example 8 at 22 minutes oven time when the part is fully densified.

FIG. 12 shows an optical microscopy photograph of the cross section of a specimen taken from a rotomolded part made using the composition of example 5 at 16 minutes oven time when the part is undercooked

FIG. 13 shows an optical microscopy photograph of the cross section of a specimen taken from a rotomolded part made using the composition of example 5 at 22 minutes oven time when the part is fully densified.

### DESCRIPTION OF EMBODIMENTS

The disclosure presents the use of ethylene copolymers with high density (>0.949 g/cm³) and broad molecular weight distributions in rotomolding applications. All examples were formulated with known additive packages for rotomolding applications. The resin formulations shown in the examples did not incorporate the densification additives (e.g. mineral oil) that are suggested in U.S. Pat. Nos. 6,362,270 and 8,961,856 but such additives may be suitable for use with the present polymer compositions. The good densification behavior of the present compositions (having broad molecular weight distribution and high density) is unexpected based on current industry guidelines and common general knowledge. The present compositions demonstrate new limits for applications requiring high density and high melt strength.

Much of the prior art teaches that polyethylene-based compositions having a narrow molecular weight distribution are desirable for rotomolding applications. Such compositions are also characterized by having relatively low melt flow ratio I₂₁/I₂. Such characteristics are associated with low melt strength. Melt strength is not often reported because it is important only in selected applications. Useful references outlining desirable characteristics of a rotational molding resin have described in the literature (R. J. Crawford and J. L. Throne (2002) “Rotational molding technology” published by Plastics Design Library ISBN 1-884207-85-5; C. T. Bellehumeur, M. Kontopoulou, J. Vlachopoulos (1998) in Rheologica Acta, Vol. 37, pp. 270-278). The inventive examples show many characteristics that fall outside these guidelines.

The present disclosure relates to rotomolded parts made from a bimodal polyethylene composition. The present polyethylene compositions are composed of at least two ethylene copolymer components: a first ethylene copolymer and a second ethylene copolymer. The polyethylene compositions of this disclosure have a good balance of processability, toughness, stiffness, and environmental stress crack resistance.

The terms “homogeneous” or “homogeneously branched polymer” as used herein define homogeneously branched polyethylene which has a relatively narrow composition distribution, as indicated by a relatively high composition distribution breadth index (CDBI). That is, the comonomer is randomly distributed within a given polymer chain and substantially all of the polymer chains have same ethylene/comonomer ratio.

It is well known that metallocene catalysts and other so called “single site catalysts” incorporate comonomer more evenly than traditional Ziegler-Natta catalysts when used for catalytic ethylene copolymerization with alpha olefins. This fact is often demonstrated by measuring the composition distribution breadth index (CDBI) for corresponding ethylene copolymers. The composition distribution of a polymer can be characterized by the short chain distribution index (SCDI) or composition distribution breadth index (CDBI). The definition of composition distribution breadth index (CDBI) can be found in PCT publication WO 93/03093 and U.S. Pat. No. 5,206,075. The CDBI is conveniently determined using techniques which isolate polymer fractions based on their solubility (and hence their comonomer content). For example, temperature rising elution fractionation (TREF) as described by Wild et al., J. Poly. Sci., Poly. Phys. Ed. Vol. 20, p. 441, 1982 or in U.S. Pat. No. 4,798,081 can be employed. From the weight fraction versus composition distribution curve, the CDBI is determined by establishing the weight percentage of a copolymer sample that has a comonomer content within 50% of the median comonomer content on each side of the median. Generally, Ziegler Natta catalysts produce ethylene copolymers with a CDBI of less than about 50%, consistent with a heterogeneously branched copolymer. In contrast, metallocenes and other single site catalysts will most often produce ethylene copolymers having a CDBI of greater than about 55%, consistent with a homogeneously branched copolymer.

### The First Ethylene Copolymer

The first ethylene copolymer of the present polyethylene composition has a density of from about 0.920 g/cm³ to about 0.955 g/cm³; a melt index, I₂, of less than about 1.0 g/10 min; a molecular weight distribution, M_{w}/Mₙ, of below about 3.0 and a weight average molecular weight, M_{w}, that is greater than the M_{w} of the second ethylene copolymer. In an embodiment, the weight average molecular weight, M_{w}, of the first ethylene copolymer is at least 110,000. In an embodiment, the first ethylene copolymer is a homogeneously branched copolymer.

By the term “ethylene copolymer” it is meant that the copolymer comprises both ethylene and at least one alpha-olefin comonomer.

In an embodiment, the first ethylene copolymer is made with a single site catalyst, such as for example a phosphinimine catalyst.

The comonomer (i.e. alpha-olefin) content in the first ethylene copolymer can be from about 0.05 to about 3.0 mol %. The comonomer content of the first ethylene polymer is determined by mathematical deconvolution methods applied to a bimodal polyethylene composition (see the Examples section). The comonomer is one or more suitable alpha olefin such as but not limited to 1-butene, 1-hexene, 1-octene and the like, with 1-octene being preferred.

The short chain branching in the first ethylene copolymer can be from about 0.25 to about 15 short chain branches per thousand carbon atoms (SCB1/1000Cs). In further embodiments, the short chain branching in the first ethylene copolymer can be from 0.5 to 15, or from 0.5 to 12, or from 0.5 to 10, or from 0.75 to 15, or from 0.75 to 12, or from 0.75 to 10, or from 1.0 to 10, or from 1.0 to 8.0, or from 1.0 to 5, or from 1.0 to 3 branches per thousand carbon atoms (SCB1/1000Cs). The short chain branching is the branching due to the presence of alpha-olefin comonomer in the ethylene copolymer and will for example have two carbon atoms for a 1-butene comonomer, or four carbon atoms for a 1-hexene comonomer, or six carbon atoms for a 1-octene comonomer, etc. The number of short chain branches in the first ethylene copolymer is determined by mathematical deconvolution methods applied to a bimodal polyethylene composition (see the Examples section). The comonomer is one or more suitable alpha olefin such as but not limited to 1-butene, 1-hexene, 1-octene and the like, with 1-octene being preferred.

In an embodiment, the comonomer content in the first ethylene copolymer is substantially similar or approximately equal (e.g. within about ±0.05 mol %) to the comonomer content of the second ethylene copolymer (as reported for example in mol %).

In an embodiment, the comonomer content in the first ethylene copolymer is greater than comonomer content of the second ethylene copolymer (as reported for example in mol %).

In an embodiment, the amount of short chain branching in the first ethylene copolymer is substantially similar or approximately equal (e.g. within about ±0.25 SCB/1000Cs) to the amount of short chain branching in the second ethylene copolymer (as reported in short chain branches, SCB per thousand carbons in the polymer backbone, 1000Cs).

In an embodiment, the amount of short chain branching in the first ethylene copolymer is greater than the amount of short chain branching in the second ethylene copolymer (as reported in short chain branches, SCB per thousand carbons in the polymer backbone, 1000Cs).

The melt index of the first ethylene copolymer can, in an embodiment, be above 0.01, but below 1.0 g/10 min.

In an embodiment, the first ethylene copolymer has a weight average molecular weight M_{w} of from about 110,000 to about 250,000. In another embodiment, the first ethylene copolymer has a weight average molecular weight M_{w} of greater than about 110,000 to less than about 250,000. In further embodiments, the first ethylene copolymer has a weight average molecular weight M_{w} of from about 125,000 to about 225,000, or from about 150,000 to 225,000.

The density of the first ethylene copolymer is from 0.920 to 0.955 g/cm³ or can be a narrower range within this range. For example, in further embodiments, the density of the first ethylene copolymer can be from 0.925 to 0.955 g/cm³, or from 0.925 to 0.950 g/cm³, or from 0.925 to 0.945 g/cm³.

In an embodiment, the first ethylene copolymer has a molecular weight distribution M_{w}/Mₙ of <3.0, or ≤2.7, or <2.7, or ≤2.5, or <2.5, or ≤2.3, or from 1.8 to 2.3.

The density and the melt index, I₂, of the first ethylene copolymer can be estimated from GPC (gel permeation chromatography) and GPC-FTIR (gel permeation chromatography with Fourier transform infra-red detection) experiments and deconvolutions carried out on the bimodal polyethylene composition (see the Examples section).

In an embodiment, the first ethylene copolymer of the polyethylene composition is a homogeneously branched ethylene copolymer having a weight average molecular weight, M_{w}, of at least 110,000; a molecular weight distribution, M_{w}/Mₙ, of less than 2.7 and a density of from 0.925 to 0.948 g/cm³.

In an embodiment, the first ethylene copolymer is homogeneously branched ethylene copolymer and has a CDBI of greater than about 50%, preferably of greater than about 55%. In further embodiments, the first ethylene copolymer has a CDBI of greater than about 60%, or greater than about 65%, or greater than about 70%.

The first ethylene copolymer can comprise from 10 to 70 weight percent (wt %) of the total weight of the first and second ethylene copolymers. In an embodiment, the first ethylene copolymer comprises from 20 to 60 weight percent (wt %) of the total weight of the first and second ethylene copolymers. In an embodiment, the first ethylene copolymer comprises from 30 to 60 weight percent (wt %) of the total weight of the first and second ethylene copolymers. In an embodiment, the first ethylene copolymer comprises from 40 to 50 weight percent (wt %) of the total weight of the first and second ethylene copolymers.

### The Second Ethylene Copolymer

The second ethylene copolymer of the present polyethylene composition has a density below 0.967 g/cm³ but which is higher than the density of the first ethylene copolymer; a melt index, I₂, of from about 100 to 20,000 g/10 min; a molecular weight distribution, M_{w}/Mₙ, of below about 3.0 and a weight average molecular weight M_{w} that is less than the M_{w} of the first ethylene copolymer. In an embodiment, the weight average molecular weight, M_{w} of the second ethylene copolymer will be below 45,000. In an embodiment, the second ethylene copolymer is a homogeneously branched copolymer.

By the term “ethylene copolymer” it is meant that the copolymer comprises both ethylene and at least one alpha-olefin comonomer.

In an embodiment, the second ethylene copolymer is made with a single site catalyst, such as for example a phosphinimine catalyst.

The comonomer content in the second ethylene copolymer can be from about 0.05 to about 3 mol % as measured by ¹³C NMR, or FTIR or GPC-FTIR methods. The comonomer content of the second ethylene polymer can also be determined by mathematical deconvolution methods applied to a bimodal polyethylene composition (see the Examples section). The comonomer is one or more suitable alpha olefin such as but not limited to 1-butene, 1-hexene, 1-octene and the like, with the use of 1-octene being preferred.

The short chain branching in the second ethylene copolymer can be from about 0.10 to about 15 short chain branches per thousand carbon atoms (SCB2/1000Cs). In further embodiments, the short chain branching in the second ethylene copolymer can be from 0.10 to 12, or from 0.10 to 8, or from 0.10 to 5, or from 0.10 to 3, or from 0.10 to 2 branches per thousand carbon atoms (SCB2/1000Cs). The short chain branching is the branching due to the presence of alpha-olefin comonomer in the ethylene copolymer and will for example have two carbon atoms for a 1-butene comonomer, or four carbon atoms for a 1-hexene comonomer, or six carbon atoms for a 1-octene comonomer, etc. The number of short chain branches in the second ethylene copolymer can be measured by ¹³C NMR, or FTIR or GPC-FTIR methods. Alternatively, the number of short chain branches in the second ethylene copolymer can be determined by mathematical deconvolution methods applied to a bimodal polyethylene composition (see the Examples section). The comonomer is one or more suitable alpha olefin such as but not limited to 1-butene, 1-hexene, 1-octene and the like, with 1-octene being preferred.

In an embodiment, the comonomer content in the second ethylene copolymer is substantially similar or approximately equal (e.g. within about ±0.05 mol %) to the comonomer content of the first ethylene copolymer (as reported for example in mol %).

In an embodiment, the comonomer content in the second ethylene copolymer is less than the comonomer content of the first ethylene copolymer (as reported for example in mol %).

In an embodiment, the amount of short chain branching in the second ethylene copolymer is substantially similar or approximately equal (e.g. within about ±0.25 SCB/1000C) to the amount of short chain branching in the first ethylene copolymer (as reported in short chain branches, SCB per thousand carbons in the polymer backbone, 1000Cs).

In an embodiment, the amount of short chain branching in the second ethylene copolymer is less than the amount of short chain branching in the first ethylene copolymer (as reported in short chain branches, SCB per thousand carbons in the polymer backbone, 1000Cs).

In most embodiments, the density of the second ethylene copolymer is less than 0.967 g/cm³. The density of the second ethylene copolymer, in an embodiment, is less than 0.966 g/cm³. In another embodiment, the density of the second ethylene copolymer is less than 0.965 g/cm³.

In an embodiment, the density of the second ethylene copolymer is from 0.952 to 0.966 g/cm³ or can be a narrower range within this range.

In an embodiment, the second ethylene copolymer has a weight average molecular weight M_{w} of less than 25,000. In another embodiment, the second ethylene copolymer has a weight average molecular weight M_{w} of from about 7,500 to about 23,000. In further embodiments, the second ethylene copolymer has a weight average molecular weight M_{w} of from about 9,000 to about 22,000, or from about 10,000 to about 17,500, or from about 7,500 to 17,500.

In an embodiment, the second ethylene copolymer has a molecular weight distribution of <3.0, or ≤2.7, or <2.7, or ≤2.5, or <2.5, or ≤2.3, or from 1.8 to 2.3.

In an embodiment, the melt index I₂ of the second ethylene copolymer can be from 20 to 20,000 g/10 min. In another embodiment, the melt index I₂ of the second ethylene copolymer can be from 100 to 20,000 g/10 min. In yet another embodiment, the melt index I₂ of the second ethylene copolymer can be from 100 to 10,000 g/10 min. In yet another embodiment, the melt index I₂ of the second ethylene copolymer can be from 1,000 to 20,000 g/10 min. In yet another embodiment, the melt index I₂ of the second ethylene copolymer can be from 1,500 but less than 10,000 g/10 min.

In an embodiment, the melt index I₂ of the second ethylene copolymer is greater than 200 g/10 min. In an embodiment, the melt index I₂ of the second ethylene copolymer is greater than 500 g/10 min. In an embodiment, the melt index 12 of the second ethylene copolymer is greater than 1,000 g/10 min. In an embodiment, the melt index I₂ of the second ethylene copolymer is greater than 1,200 g/10 min. In an embodiment, the melt index I₂ of the second ethylene copolymer is greater than 1,500 g/10 min.

The density of the second ethylene copolymer may be measured according to ASTM D792. The melt index, I₂, of the second ethylene copolymer may be measured according to ASTM D1238 (when conducted at 190° C., using a 2.16 kg weight).

The density and the melt index, I₂, of the second ethylene copolymer can be estimated from GPC and GPC-FTIR experiments and deconvolutions carried out on a bimodal polyethylene composition (see the below Examples section).

In an embodiment, the second ethylene copolymer of the polyethylene composition is a homogeneous ethylene copolymer having a weight average molecular weight, M_{w}, of at most 45,000; a molecular weight distribution, M_{w}/Mₙ, of less than 2.7 and a density higher than the density of said first ethylene copolymer, but less than 0.967 g/cm³.

In an embodiment, the second ethylene copolymer is homogeneously branched ethylene copolymer and has a CDBI of greater than about 50%, especially greater than about 55%. In further embodiments, the second ethylene copolymer has a CDBI of greater than about 60%, or greater than about 65%, or greater than about 70%.

The second ethylene copolymer can comprise from 90 to 30 wt % of the total weight of the first and second ethylene copolymers. In an embodiment, the second ethylene copolymer comprises from 80 to 40 wt % of the total weight of the first and second ethylene copolymers. In an embodiment, the second ethylene copolymer comprises from 70 to 40 wt % of the total weight of the first and second ethylene copolymers. In an embodiment, the second ethylene copolymer comprises from 60 to 50 wt % of the total weight of the first and second ethylene copolymers.

In most embodiments, the second ethylene copolymer has a density which is higher than the density of the first ethylene copolymer, but less than about 0.037 g/cm³ higher than the density of the first ethylene copolymer. In an embodiment, the second ethylene copolymer has a density which is higher than the density of the first ethylene copolymer, but less than about 0.035 g/cm³ higher than the density of the first ethylene copolymer. In another embodiment, the second ethylene copolymer has a density which is higher than the density of the first ethylene copolymer, but less than about 0.031 g/cm³ higher than the density of the first ethylene copolymer. In still another embodiment, the second ethylene copolymer has a density which is higher than the density of the first ethylene copolymer, but less than about 0.030 g/cm³ higher than the density of the first ethylene copolymer.

In embodiments, the 12 of the second ethylene copolymer is at least 100 times, or at least 1,000 times, or at least 10,000 the 12 of the first ethylene copolymer.

### The Polyethylene Composition

The present polyethylene composition has a broad, bimodal or multimodal molecular weight distribution. Minimally, the polyethylene composition will contain a first ethylene copolymer and a second ethylene copolymer (as defined above) which are of different weight average molecular weight (M_{w}).

The polyethylene composition will minimally comprise a first ethylene copolymer and a second ethylene copolymer (as defined above) and the ratio (SCB1/SCB2) of the number of short chain branches per thousand carbon atoms in the first ethylene copolymer (i.e. SCB1) to the number of short chain branches per thousand carbon atoms in the second ethylene copolymer (i.e. SCB2) will be greater than 0.5 (i.e. SCB1/SCB2>0.5).

In an embodiment, the ratio of the short chain branching in the first ethylene copolymer (SCB1) to the short chain branching in the second ethylene copolymer (SCB2) is at least 0.60. In another embodiment, the ratio of the short chain branching in the first ethylene copolymer (SCB1) to the short chain branching in the second ethylene copolymer (SCB2) is at least 0.75. In another embodiment, the ratio of the short chain branching in the first ethylene copolymer (SCB1) to the short chain branching in the second ethylene copolymer (SCB2) is at least 1.0. In yet another embodiment, the ratio of the short chain branching in the first ethylene copolymer (SCB1) to the short chain branching in the second ethylene copolymer (SCB2) is at least 1.25. In still another embodiment, the ratio of the short chain branching in the first ethylene copolymer (SCB1) to the short chain branching in the second ethylene copolymer (SCB2) is at least 1.5.

In embodiments, the ratio (SCB1/SCB2) of the short chain branching in the first ethylene copolymer (SCB1) to the short chain branching in the second ethylene copolymer (SCB2) will be from 0.75 to 12.0, or from 1.0 to 10, or from 1.0 to 7.0, or from 1.0 to 5.0, or from 1.0 to 3.0.

In a specific embodiment, the polyethylene composition has a bimodal molecular weight distribution. In the current disclosure, the term “bimodal” means that the polyethylene composition comprises at least two components, one of which has a lower weight average molecular weight and a higher density and another of which has a higher weight average molecular weight and a lower density.

Typically, a bimodal or multimodal polyethylene composition can be identified by using gel permeation chromatography (GPC). Generally, the GPC chromatograph will exhibit two or more component ethylene copolymers, where the number of component ethylene copolymers corresponds to the number of discernible peaks. One or more component ethylene copolymers may also exist as a hump, shoulder or tail relative to the molecular weight distribution of the other ethylene copolymer component.

The polyethylene composition of this disclosure has a density of greater than or equal to 0.949 g/cm³, as measured according to ASTM D792; a melt index, I₂, of from about 0.4 to about 5.0 g/10 min, as measured according to ASTM D1238 (when conducted at 190° C., using a 2.16 kg weight); a molecular weight distribution, M_{w}/Mₙ, of from about 3 to about 11, a Z-average molecular weight, M_{z} of less than 400,000, a stress exponent of less than 1.50 and an ESCR Condition B at 10% of at least 20 hours.

In an embodiment, the polyethylene composition has a density of greater than or equal to 0.950 g/cm³, as measured according to ASTM D792; a melt index, 121, of from about 150 to about 400 g/10 min, as measured according to ASTM D1238 (when conducted at 190° C., using a 21.6 kg weight); a molecular weight distribution, M_{w}/Mₙ, of from about 3 to about 7, a Z-average molecular weight, M_{z} of less than 400,000, a stress exponent of less than 1.40 and a relative elasticity defined as the ratio of G′/G″ at frequency of 0.05 rad/s, less than 1.3.

In embodiments, the polyethylene composition has a comonomer content of less than 0.75 mol %, or less than 0.70 mol %, or less than 0.65 mol %, or less than 0.60 mol %, or less than 0.55 mol % as measured by FTIR or ¹³C NMR methods, with ¹³C NMR being preferred, where the comonomer is one or more suitable alpha olefins such as but not limited to 1-butene, 1-hexene, 1-octene and the like, with 1-octene being used in some embodiments. In an embodiment, the polyethylene composition has a comonomer content of from 0.1 to 0.75 mol %, or from 0.10 to 0.55 mol %, or from 0.20 to 0.50 mol %.

The present polyethylene composition has a density of at least 0.949 g/cm³. In some embodiments, the polyethylene composition has a density of >0.949 g/cm³, or ≥0.950 g/cm³.

In an embodiment, the polyethylene composition has a density in the range of from 0.949 to 0.960 g/cm³.

In an embodiment, the polyethylene composition has a density in the range of from 0.949 to 0.959 g/cm³.

In an embodiment, the polyethylene composition has a density in the range of from 0.949 to 0.957 g/cm³.

In an embodiment, the polyethylene composition has a density in the range of from 0.950 to 0.955 g/cm³.

In an embodiment, the polyethylene composition has a density in the range of from 0.951 to 0.957 g/cm³.

In an embodiment, the polyethylene composition has a density in the range of from 0.951 to 0.955 g/cm³.

In an embodiment, the polyethylene composition has a melt index, I₂, of between 0.4 and 5.0 g/10 min according to ASTM D1238 (when conducted at 190° C., using a 2.16 kg weight) and including narrower ranges within this range. For example, in further embodiments, the polyethylene composition has a melt index, I₂, of from 0.5 to 5.0 g/10 min, or from 0.4 to 3.5 g/10 min, or from 0.4 to 3.0 g/10 min, or from 0.5 to 3.5 g/10 min, or from 0.5 to 3.0 g/10 min, or from 1.0 to 3.0 g/10 min, or from about 1.0 to about 2.0 g/10 min, or from more than 0.5 to less than 2.0 g/10 min.

In an embodiment, the polyethylene composition has a high load melt index, 121 of at least 25 g/10 min according to ASTM D1238 (when conducted at 190° C., using a 21 kg weight). In another embodiment, the polyethylene composition has a high load melt index, I₂₁, of greater than about 50 g/10 min. In yet another embodiment, the polyethylene composition has a high load melt index, I₂₁, of greater than about 75 g/10 min. In still another embodiment, the polyethylene composition has a high load melt index, I₂₁, of greater than about 100 g/10 min. In an embodiment, the polyethylene composition has a complex viscosity, η* at a shear stress anywhere between from about 1 to about 10 kPa which is between 1,000 to 25,000 Pa·s. In an embodiment, the polyethylene composition has a complex viscosity, η* at a shear stress anywhere from about 1 to about 10 kPa which is between 1,000 to 10,000 Pa·s.

In an embodiment, the polyethylene composition has a number average molecular weight, Mₙ, of below about 30,000. In another embodiment, the polyethylene composition has a number average molecular weight, Mₙ, of below about 20,000.

In the present disclosure, the polyethylene composition has a molecular weight distribution M_{w}/Mₙ of from 3 to 11 or a narrower range within this range. For example, in further embodiments, the polyethylene composition has a M_{w}/Mₙ of from 4.0 to 10.0, or from 4.0 to 9.0 or from 5.0 to 10.0, or from 5.0 to 9.0, or from 4.5 to 10.0, or from 4.5 to 9.5, or from 4.5 to 9.0, or from 4.5 to 8.5, or from 5.0 to 8.5.

In an embodiment, the polyethylene composition has a ratio of Z-average molecular weight to weight average molecular weight (M_{z}/M_{w}) of from 2.25 to 4.5, or from 2.5 to 4.25, or from 2.75 to 4.0, or from 2.75 to 3.75, or between 2.5 and 4.0.

In embodiments, the polyethylene composition has a melt flow ratio defined as 121/12 of >30, or >40, or ≥45, or ≥50, or ≥60. In a further embodiment, the polyethylene composition has a melt flow ratio 121/12 of from about 22 to about 60 and including narrower ranges within this range. For example, the polyethylene composition may have a melt flow ratio 121/12 of from about 30 to about 70, or from about 40 to 60.

In an embodiment, the shear thinning index, SHI_{(1,100)} of the polyethylene composition is less than about 10; in another embodiment the SHI_{(1,100)} will be less than about 7. The shear thinning index (SHI), was calculated using dynamic mechanical analysis (DMA) frequency sweep methods as disclosed in PCT applications WO 2006/048253 and WO 2006/048254. The SHI value is obtained by calculating the complex viscosities η*(1) and η* (100) at a constant shear stress of 1 kPa (G*) and 100 kPa (G*), respectively.

In an embodiment, the SHI_{(1,100)} of the polyethylene composition satisfies the equation: SHI_{(1,100)}<−10.58 (log I₂ of polyethylene composition in g/10 min) (g/10 min)+12.94. In another embodiment, the SHI_{(1,100)} of the polyethylene composition satisfies the equation:

SHI_{(1,100)}<−5.5 (log I₂ of the polyethylene composition in g/10 min) (g/10 min)+9.66.

In an embodiment, the polyethylene composition or a molded article made from the polyethylene composition, has an environment stress crack resistance ESCR Condition B at 10% of at least 20 hours, as measured according to ASTM D1693 (at 10% IGEPAL® and 50° C. under condition B).

In an embodiment, the polyethylene composition or a molded article made from the polyethylene composition, has an environment stress crack resistance ESCR Condition B at 10% of at least 60 hours, as measured according to ASTM D1693 (at 10% IGEPAL and 50° C. under condition B).

In an embodiment, the polyethylene composition or a molded article made from the polyethylene composition, has an environment stress crack resistance ESCR Condition B at 10% of at least 80 hours, as measured according to ASTM D1693 (at 10% IGEPAL and 50° C. under condition B).

In an embodiment, the polyethylene composition or a molded article made from the polyethylene composition, has an environment stress crack resistance ESCR Condition B at 10% of at least 120 hours, as measured according to ASTM D1693 (at 10% IGEPAL and 50° C. under condition B).

In an embodiment, the polyethylene composition or a molded article made from the polyethylene composition, has an environment stress crack resistance ESCR Condition B at 10% of at least 150 hours, as measured according to ASTM D1693 (at 10% IGEPAL and 50° C. under condition B).

In an embodiment, the polyethylene composition has a stress exponent, defined as Log₁₀[I₆/I₂]/Log₁₀[6.48/2.16], which is 1.50. In further embodiments, the polyethylene composition has a stress exponent, Log₁₀[I₆/I₂]/Log₁₀[6.48/2.16] of less than 1.50, or less than 1.48, or less than 1.45.

In an embodiment, the polyethylene composition has a comonomer distribution breadth index (CDBI), as determined by temperature elution fractionation (TREF), of ≥60%. In further embodiments, the polyethylene composition will have a CDBI of greater than 65%, or greater than 70%.

The present polyethylene composition can be made using any conventional blending method such as but not limited to physical blending and in-situ blending by polymerization in multi reactor systems. For example, it is possible to perform the mixing of the first ethylene copolymer with the second ethylene copolymer by molten mixing of the two preformed polymers. Preferred are processes in which the first and second ethylene copolymers are prepared in at least two sequential polymerization stages, however, both in-series or an in-parallel dual reactor process are contemplated for use to prepare the present compositions. Gas phase, slurry phase or solution phase reactor systems may be used, with solution phase reactor systems being preferred.

In an embodiment, a dual reactor solution process is used as has been described in for example U.S. Pat. No. 6,372,864 and U.S. Patent Appl. No. 20060247373A1.

Homogeneously branched ethylene copolymers can be prepared using any catalyst capable of producing homogeneous branching. Generally, the catalysts will be based on a group 4 metal having at least one cyclopentadienyl ligand that is well known in the art. Examples of such catalysts which include metallocenes, constrained geometry catalysts and phosphinimine catalysts are typically used in combination with activators selected from methylaluminoxanes, boranes or ionic borate salts and are further described in U.S. Pat. Nos. 3,645,992; 5,324,800; 5,064,802; 5,055,438; 6,689,847; 6,114,481 and 6,063,879. Such catalysts may also be referred to as “single site catalysts” to distinguish them from traditional Ziegler-Natta or Phillips catalysts which are also well known in the art. In general, single site catalysts produce ethylene copolymers having a molecular weight distribution (M_{w}/Mₙ) of less than about 3.0 and a composition distribution breadth index (CDBI) of greater than about 50%.

In an embodiment, homogeneously branched ethylene polymers are prepared using an organometallic complex of a group 3, 4 or 5 metal that is further characterized as having a phosphinimine ligand. Such catalysts are known generally as phosphinimine catalysts. Some non-limiting examples of phosphinimine catalysts can be found in U.S. Pat. Nos. 6,342,463; 6,235,672; 6,372,864; 6,984,695; 6,063,879; 6,777,509 and 6,277,931.

Some non-limiting examples of metallocene catalysts can be found in U.S. Pat. Nos. 4,808,561; 4,701,432; 4,937,301; 5,324,800; 5,633,394; 4,935,397; 6,002,033 and 6,489,413. Some non-limiting examples of constrained geometry catalysts can be found in U.S. Pat. Nos. 5,057,475; 5,096,867; 5,064,802; 5,132,380; 5,703,187 and 6,034,021.

In an embodiment, the use of a single site catalyst that does not produce long chain branching (LCB) is used. Without wishing to be bound by any single theory, long chain branching can increase viscosity at low shear rates, thereby negatively impacting cycle times during the manufacture of rotomolded parts. Long chain branching may be determined using ¹³C NMR methods and may be quantitatively assessed using the method disclosed by Randall in Rev. Macromol. Chem. Phys. C29 (2 and 3), p. 285.

In an embodiment, the polyethylene composition will contain fewer than 0.3 long chain branches per 1,000 carbon atoms. In another embodiment, the polyethylene composition will contain fewer than 0.01 long chain branches per 1,000 carbon atoms.

In an embodiment, the polyethylene composition (defined as above) is prepared by contacting ethylene and at least one alpha-olefin with a polymerization catalyst under solution phase polymerization conditions in at least two polymerization reactors (for an example of solution phase polymerization conditions see for example U.S. Pat. Nos. 6,372,864; 6,984,695 and U.S. Appl. No. 20060247373A1.

In an embodiment, the polyethylene composition is prepared by contacting at least one single site polymerization catalyst system (comprising at least one single site catalyst and at least one activator) with ethylene and a least one comonomer (e.g. a C3-C8 alpha-olefin) under solution polymerization conditions in at least two polymerization reactors.

In an embodiment, a group 4 single site catalyst system, comprising a single site catalyst and an activator, is used in a solution phase dual reactor system to prepare a bimodal polyethylene composition by polymerization of ethylene in the presence of an alpha-olefin comonomer.

In an embodiment, a group 4 single site catalyst system, comprising a single site catalyst and an activator, is used in a solution phase dual reactor system to prepare a bimodal polyethylene composition by polymerization of ethylene in the presence of 1-octene.

In an embodiment, a group 4 phosphinimine catalyst system, comprising a phosphinimine catalyst and an activator, is used in a solution phase dual reactor system to prepare a bimodal polyethylene composition by polymerization of ethylene in the presence of an alpha-olefin comonomer.

In an embodiment, a group 4 phosphinimine catalyst system, comprising a phosphinimine catalyst and an activator, is used in a solution phase dual reactor system to prepare a bimodal polyethylene composition by polymerization of ethylene in the presence of 1-octene.

In an embodiment, a solution phase dual reactor system comprises two solution phase reactors connected in series.

In an embodiment, a polymerization process to prepare the polyethylene composition comprises contacting at least one single site polymerization catalyst system with ethylene and at least one alpha-olefin comonomer under solution polymerization conditions in at least two polymerization reactors.

In an embodiment, a polymerization process to prepare the polyethylene composition comprises contacting at least one single site polymerization catalyst system with ethylene and at least one alpha-olefin comonomer under solution polymerization conditions in a first reactor and a second reactor configured in series.

In an embodiment, a polymerization process to prepare the polyethylene composition comprises contacting at least one single site polymerization catalyst system with ethylene and at least one alpha-olefin comonomer under solution polymerization conditions in a first reactor and a second reactor configured in series, with the at least one alpha-olefin comonomer being fed exclusively to the first reactor.

The production of the present polyethylene composition will typically include an extrusion or compounding step. Such steps are well known in the art.

The polyethylene composition can comprise further polymer components in addition to the first and second ethylene polymers. Such polymer components include polymers made in situ or polymers added to the polymer composition during an extrusion or compounding step.

Optionally, additives can be added to the polyethylene composition. Additives can be added to the polyethylene composition during an extrusion or compounding step, but other suitable known methods will be apparent to a person skilled in the art. The additives can be added as is or as part of a separate polymer component (i.e. not the first or second ethylene polymers described above) added during an extrusion or compounding step. Suitable additives are known in the art and include but are not-limited to antioxidants, phosphites and phosphonites, nitrones, antacids, UV light stabilizers, UV absorbers, metal deactivators, dyes, fillers and reinforcing agents, nano-scale organic or inorganic materials, antistatic agents, release agents such as zinc stearates, and nucleating agents (including nucleators, pigments or any other chemicals which may provide a nucleating effect to the polyethylene composition). The additives that can be optionally added are typically added in amount of up to 20 weight percent (wt %). Description of the additives follow.

### Phosphites

### Aryl Monophosphite

As used herein, the term aryl monophosphite refers to a phosphite stabilizer which contains:

(1) only one phosphorus atom per molecule; and

(2) at least one aryloxide (which may also be referred to as phenoxide) radical which is bonded to the phosphorus.

Preferred aryl monophosphites contain three aryloxide radicals—for example, tris phenyl phosphite is the simplest member of this preferred group of aryl monophosphites.

Highly preferred aryl monophosphites contain C₁ to C₁₀ alkyl substituents on at least one of the aryloxide groups. These substituents may be linear (as in the case of nonyl substituents) or branched (such as isopropyl or tertiary butyl substituents).

Non-limiting examples of suitable aryl monophosphites follow. Preferred aryl monophosphites are indicated by the use of trademarks in square brackets.

Triphenyl phosphite; diphenyl alkyl phosphites; phenyl dialkyl phosphites; tris(nonylphenyl) phosphite [WESTON® 399, available from GE Specialty Chemicals]; tris(2,4-di-tert-butylphenyl) phosphite [IRGAFOS® 168, available from Ciba Specialty Chemicals Corp.]; and bis(2,4-di-tert-butyl-6-methylphenyl) ethyl phosphite [IRGAFOS 38, available from Ciba Specialty Chemicals Corp.]; and 2,2′,2″-nitrilo[triethyltris(3,3′5,5′-tetra-tert-butyl-1,1′-biphenyl-2,2′-diyl) phosphite [IRGAFOS 12, available from Ciba Specialty Chemicals Corp.].

In an embodiment, the amount of aryl monophosphite is from 200 to 2,000 ppm (based on the weight of the polyolefin), preferably from 300 to 1,500 ppm and most preferably from 400 to 1,000 ppm.

### Phosphite or Diphosphite

As used herein, the term diphosphite refers to a phosphite stabilizer which contains at least two phosphorus atoms per phosphite molecule (and, similarly, the term diphosphonite refers to a phosphonite stabilizer which contains at least two phosphorus atoms per phosphonite molecule).

Non-limiting examples of suitable diphosphites and diphosphonites follow: distearyl pentaerythritol diphosphite, diisodecyl pentaerythritol diphosphite, bis(2,4 di-tert-butylphenyl) pentaerythritol diphosphite [ULTRANOX® 626, available from GE Specialty Chemicals]; bis(2,6-di-tert-butyl-4-methylpenyl) pentaerythritol diphosphite; bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tetrakis(2,4-di-tert-butylphenyl)4,4′-bipheylene diphosphonite [IRGAFOS P-EPQ, available from Ciba] and bis(2,4-dicumylphenyl)pentaerythritol diphosphite [DOVERPHOS® 59228-T or DOVERPHOS S9228-CT].

P-EPQ® (CAS No 119345-01-06) is an example of a commercially available diphosphonite.

In an embodiment, the diphosphite and/or diphosphonite are used in amounts of from 200 ppm to 2,000 ppm, preferably from 300 to 1,500 ppm and most preferably from 400 to 1,000 ppm.

The use of diphosphites is preferred over the use of diphosphonites. The most preferred diphosphites are those available under the trademarks DOVERPHOS S9228-CT and ULTRANOX 626.

### Hindered Phenolic Antioxidant

The hindered phenolic antioxidant may be any of the molecules that are conventionally used as primary antioxidants for the stabilization of polyolefins. Suitable examples include 2,6-di-tert-butyl-4-methylphenol; 2-tert-butyl-4,6-dimethylphenol; 2,6-di-tert-butyl-4-ethylphenol; 2,6-di-tert-butyl-4-n-butylphenol; 2,6-di-tert-butyl-4isobutylphenol; 2,6-dicyclopentyl-4-methylphenol; 2-(.alpha.-methylcyclohexyl)-4,6 dimethylphenol; 2,6-di-octadecyl-4-methylphenol; 2,4,6,-tricyclohexyphenol; and 2,6-di-tert-butyl-4-methoxymethylphenol.

Two (non-limiting) examples of suitable hindered phenolic antioxidants are sold under the trademarks IRGANOX® 1010 (CAS Registry number 6683-19-8) and IRGANOX 1076 (CAS Registry number 2082-79-3) by BASF Corporation.

In an embodiment, the hindered phenolic antioxidant is used in an amount of from 100 to 2,000 ppm, especially from 400 to 1,000 ppm (based on the weight of said thermoplastic polyethylene product).

### Long Term Stabilizers

Plastic parts which are intended for long term use preferably contain at least one Hindered Amine Light Stabilizer (HALS). HALS are well known to those skilled in the art.

When employed, the HALS is preferably a commercially available material and is used in a conventional manner and amount.

Commercially available HALS include those sold under the trademarks CHIMASSORB® 119; CHIMASSORB 944; CHIMASSORB 2020; TINUVIN® 622 and TINUVIN 770 from Ciba Specialty Chemicals Corporation, and CYASORB UV 3346, CYASORB® UV 3529, CYASORB UV 4801, and CYASORB UV 4802 from Cytec Industries. In some embodiments, TINUVIN 622 is preferred. Mixtures of more than one HALS are also contemplated.

Suitable HALS include: bis(2,2,6,6-tetramethylpiperidyl)-sebacate; bis-5(1,2,2,6,6-pentamethylpiperidyl)-sebacate; n-butyl-3,5-di-tert-butyl-4-hydroxybenzyl malonic acid bis(1,2,2,6,6,-pentamethylpiperidyl)ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylendiamine and 4-tert-octylamino-2,6-dichloro-1,3,5-s-triazine; tris-(2,2,6,6-tetramethylpiperidyl)-nitrilotriacetate, tetrakis-(2,2,6,6-tetramethyl-4-piperidyl)-1,2,3,4butane-tetra-arbonic acid; and 1,1′(1,2-ethanediyl)-bis-(3,3,5,5-tetramethylpiperazinone).

### Hydroxylamines

It is known to use hydroxylamines and derivatives thereof (including amine oxides) as additives for polyethylene compositions used to prepare rotomolded parts, as disclosed in U.S. Pat. No. 6,444,733 (Stader, to Ciba)—and the hydroxylamines and derivatives disclosed in this patent are also suitable for use in the present disclosure. Suitable examples include N,N-dialkylhydroxylamines: a commercially available example is the N,N-di(alkyl) hydroxylamine sold as IRGASTAB® 042 (by BASF) which is reported to be prepared by the direct oxidation of N,N-di(hydrogenated) tallow amine.

One or more nucleating agent(s) may be introduced into the polyethylene composition by kneading a mixture of the polymer, usually in powder or pellet form, with the nucleating agent, which may be utilized alone or in the form of a concentrate containing further additives such as stabilizers, pigments, antistatics, UV stabilizers and fillers. It should be a material which is wetted or absorbed by the polymer, which is insoluble in the polymer and of melting point higher than that of the polymer, and it should be homogeneously dispersible in the polymer melt in as fine a form as possible (1 to 10 μm). Compounds known to have a nucleating capacity for polyolefins include salts of aliphatic monobasic or dibasic acids or arylalkyl acids, such as sodium succinate or aluminum phenylacetate; and alkali metal or aluminum salts of aromatic or alicyclic carboxylic acids such as sodium β-naphthoate. Another compound known to have nucleating capacity is sodium benzoate. The effectiveness of nucleation may be monitored microscopically by observation of the degree of reduction in size of the spherulites into which the crystallites are aggregated.

The polymer compositions described above are used in the formation of molded articles.

The polyethylene compositions are useful for the preparation of rotomolded articles. In an embodiment, polyethylene compositions having a melt index (I₂) of from 0.4 to 2 g/10 min are used to prepare very large tanks (i.e. tanks having a volume in excess of 2,000 liters)—and— a very long molding time (in excess of 2 hours) may be used to prepare these parts. In an embodiment, polyethylene compositions having a higher melt index (I₂) of from 5 to 8 g/10 min are used to prepare smaller parts.

In an embodiment, the bimodal polyethylene composition contains an additive package comprising

1) a hindered monophosphite;

2) a diphosphite;

3) a hindered amine light stabilizer; and

4) at least one additional additive selected from the group consisting of a hindered phenol and a hydroxylamine.

The invention is further illustrated by the following non-limiting examples.

### EXAMPLES

Examples 1 to 6 were manufactured at a commercial scale production plant, using a dual reactor solution polymerization process. Examples 7 and 8 were manufactured at a commercial scale production plant, using a single reactor gas-phase polymerization process. Examples 9 and 10 were manufactured at a pilot scale production plant, using a dual-reactor solution phase polymerization process. Resins' composition was modified to provide adequate resin stabilization by melt compounding.

Example 1 contained the following additives (all amounts shown in parts per million by weight of the polyethylene): Hindered phenol (1076): 487 ppm; Phosphite (CAS Registry number 31570-04-4): 799 ppm; Diphosphite (CAS Registry number 154862-43-8): 433 ppm; Hydroxylamine (CAS Registry number 143925-92-2): 250 ppm; Hindered Amine Light Stabilizer (HALS CHIMASSORB 944): 750 ppm; HYPERFORM® HPN-20E (nucleating agent): 1,200 ppm; DHT-4V: 300 ppm.

Example 2 contained the following additives (all amounts shown in parts per million by weight of the polyethylene): Phosphite (CAS Registry number 31570-04-4): 1311 ppm; Diphosphite (CAS Registry number 154862-43-8): 508 ppm; Hydroxylamine (CAS Registry number 143925-92-2): 250 ppm; Hindered Amine Light Stabilizer (HALS CHIMASSORB 944): 750 ppm; Zinc Oxide: 750 ppm.

Example 3 contained the following additives (all amounts shown in parts per million by weight of the polyethylene): Hindered phenol (1010 and 1076): 508 ppm total (8 ppm for 1,076 and 500 ppm for 1010); Phosphite (CAS Registry number 31570-04-4): 1,550 ppm; Diphosphite (CAS Registry number 154862-43-8): 450 ppm; Hydroxylamine (CAS Registry number 143925-92-2): 250 ppm; Hindered Amine Light Stabilizer (HALS CHIMASSORB 944): 750 ppm; Zinc Oxide: 750 ppm.

Example 4 contained the following additives (all amounts shown in parts per million by weight of the polyethylene): Phosphite (CAS Registry number 31570-04-4): 1,550 ppm; Diphosphite (CAS Registry number 154862-43-8): 450 ppm; Hydroxylamine (CAS Registry number 143925-92-2): 250 ppm; Hindered Amine Light Stabilizer (HALS CHIMASSORB 944): 750 ppm; Zinc Oxide: 750 ppm.

Example 5 contained the following additives (all amounts shown in parts per million by weight of the polyethylene): Phosphite (CAS Registry number 31570-04-4): 550 ppm; Diphosphite (CAS Registry number 154862-43-8): 450 ppm; Hydroxylamine (CAS Registry number 143925-92-2): 250 ppm; Hindered Amine Light Stabilizer (HALS CHIMASSORB 944): 750 ppm; Zinc Oxide: 750 ppm.

Example 6 contained the following additives (all amounts shown in parts per million by weight of the polyethylene): Phosphite (CAS Registry number 31570-04-4): 550 ppm; Diphosphite (CAS Registry number 154862-43-8): 450 ppm; Hydroxylamine (CAS Registry number 143925-92-2): 250 ppm; Hindered Amine Light Stabilizer (HALS CHIMASSORB 944): 750 ppm; Zinc Oxide: 750 ppm.

Example 7 contained the following additives (all amounts shown in parts per million by weight of the polyethylene): Hindered phenol (IRGANOX 1076) 501 ppm; Phosphite (CAS Registry number 31570-04-4): 1,001 ppm; Hindered Amine Light Stabilizer (HALS CYASORB UV-3529): 1,000 ppm; Zinc Oxide: 1 ppm.

Example 8 contained the following additives (all amounts shown in parts per million by weight of the polyethylene): Hindered phenol (IRGANOX 1076) 502 ppm; Phosphite (CAS Registry number 31570-04-4): 1,503 ppm; Hindered Amine Light Stabilizer (HALS CYASORB UV-3346): 2,100 ppm; Zinc Oxide: 502 ppm; Zinc Stearate: 500 ppm.

Example 9 contained the following additives (all amounts shown in parts per million by weight of the polyethylene): Phosphite (CAS Registry number 31570-04-4): 550 ppm; Diphosphite (CAS Registry number 154862-43-8): 450 ppm; Hydroxylamine (CAS Registry number 143925-92-2): 400 ppm; Hindered Amine Light Stabilizer (HALS CHIMASSORB 944): 750 ppm; Zinc Oxide: 750 ppm.

Example 10 contained the following additives (all amounts shown in parts per million by weight of the polyethylene): Phosphite (CAS Registry number 31570-04-4): 550 ppm; Diphosphite (CAS Registry number 154862-43-8): 450 ppm; Hydroxylamine (CAS Registry number 143925-92-2): 400 ppm; Hindered Amine Light Stabilizer (HALS CHIMASSORB 944): 750 ppm; Zinc Oxide: 750 ppm.

Mₙ, M_{w}, and M_{z} (g/mol) were determined by high temperature Gel Permeation Chromatography (GPC) with differential refractive index (DRI) detection using universal calibration (e.g. ASTM-D6474-99). GPC data was obtained using an instrument sold under the trade name “Waters 150c”, with 1,2,4-trichlorobenzene as the mobile phase at 140° C. The samples were prepared by dissolving the polymer in this solvent and were run without filtration. Molecular weights are expressed as polyethylene equivalents with a relative standard deviation of 2.9% for the number average molecular weight (“Mₙ”) and 5.0% for the weight average molecular weight (“M_{w}”). The molecular weight distribution (MWD) is the weight average molecular weight divided by the number average molecular weight, M_{w}/Mₙ. The z-average molecular weight distribution is M_{z}/M_{w}. Polymer sample solutions (1 to 2 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a PL 220 high-temperature chromatography unit equipped with four SHODEX® columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect the columns from oxidative degradation. The sample injection volume was 200 mL. The raw data were processed with CIRRUS® GPC software. The columns were calibrated with narrow distribution polystyrene standards. The polystyrene molecular weights were converted to polyethylene molecular weights using the Mark-Houwink equation, as described in the ASTM standard test method D6474.

Primary melting peak (° C.), heat of fusion (J/g) and crystallinity (%) was determined using differential scanning calorimetry (DSC) as follows: the instrument was first calibrated with indium; after the calibration, a polymer specimen is equilibrated at 0° C. and then the temperature was increased to 200° C. at a heating rate of 10° C./min; the melt was then kept isothermally at 200° C. for five minutes; the melt was then cooled to 0° C. at a cooling rate of 10° C./min and kept at 0° C. for five minutes; the specimen was then heated to 200° C. at a heating rate of 10° C./min. The DSC Tm, heat of fusion and crystallinity are reported from the 2^{nd} heating cycle.

The short chain branch frequency (SCB per 1000 carbon atoms) of copolymer samples was determined by Fourier Transform Infrared Spectroscopy (FTIR) as per the ASTM D6645-01 method. A Thermo-Nicolet 750 Magna-IR Spectrophotometer equipped with OMNIC® version 7.2a software was used for the measurements.

Comonomer content can also be measured using ¹³C NMR techniques as discussed in Randall, Rev. Macromol. Chem. Phys., C29 (2&3), p 285; U.S. Pat. No. 5,292,845 and WO 2005/121239.

Polyethylene composition density (g/cm³) was measured according to ASTM D792.

Shear viscosity was measured by using a Kayeness WinKARS Capillary Rheometer (model #D5052M-115). For the shear viscosity at lower shear rates, a die having a die diameter of 0.06 inch and L/D ratio of 20 and an entrance angle of 180 degrees was used. For the shear viscosity at higher shear rates, a die having a die diameter of 0.012 inch and L/D ratio of 20 was used.

Melt indexes, 12,16 and 121 for the polyethylene composition were measured according to ASTM D1238 (when conducted at 190° C., using a 2.16 kg, a 6.48 kg and a 21 kg weight respectively).

To determine CDBI, a solubility distribution curve is first generated for the polyethylene composition. This is accomplished using data acquired from the TREF technique. This solubility distribution curve is a plot of the weight fraction of the copolymer that is solubilized as a function of temperature. This is converted to a cumulative distribution curve of weight fraction versus comonomer content, from which the CDBI is determined by establishing the weight percentage of a copolymer sample that has a comonomer content within 50% of the median comonomer content on each side of the median (See WO 93/03093 and U.S. Pat. No. 5,376,439).

The specific temperature rising elution fractionation (TREF) method used herein was as follows. Polymer samples (50 to 150 mg) were introduced into the reactor vessel of a crystallization-TREF unit (Polymer Char). The reactor vessel was filled with 20 to 40 mL 1,2,4-trichlorobenzene (TCB), and heated to the desired dissolution temperature (e.g. 150° C.) for 1 to 3 hours. The solution (0.5 to 1.5 mL) was then loaded into the TREF column filled with stainless steel beads. After equilibration at a given stabilization temperature (e.g. 110° C.) for 30 to 45 minutes, the polymer solution was allowed to crystallize with a temperature drop from the stabilization temperature to 30° C. (0.1 or 0.2° C./minute). After equilibrating at 30° C. for 30 minutes, the crystallized sample was eluted with TCB (0.5 or 0.75 mL/minute) with a temperature ramp from 30° C. to the stabilization temperature (0.25 or 1.0° C./minute). The TREF column was cleaned at the end of the run for 30 minutes at the dissolution temperature. The data were processed using Polymer Char software, Excel spreadsheet and TREF software developed in-house.

The melt index, I₂ and density of the first and second ethylene copolymers were estimated by GPC and GPC-FTIR deconvolutions as discussed further below.

High temperature GPC equipped with an online FTIR detector (GPC-FTIR) was used to measure the comonomer content as the function of molecular weight.

Mathematical deconvolutions were performed to determine the relative amount of polymer, molecular weight, and comonomer content of the component made in each reactor, by assuming that each polymer component follows a Flory molecular weight distribution function and it has a homogeneous comonomer distribution across the whole molecular weight range.

For these single site catalyzed resins, the GPC data from GPC chromatographs was fit based on Flory's molecular weight distribution function. During the deconvolution, the overall Mn, M_{w} and Mz are calculated with the following relationships: Mn=1/Sum(wi/Mn(i)), Mw=Sum(wi×Mw(i)), Mz=Sum(wi×Mz(i)2), where i represents the i-th component and wi represents the relative weight fraction of the i-th component in the composition.

The uniform comonomer distribution (which results from the use of a single site catalyst) of the resin components (i.e., the first and second ethylene copolymers) allowed the estimation of the short chain branching content (SCB) from the GPC-FTIR data, in branches per 1,000 carbon atoms and calculation of comonomer content (in mol %) and density (in g/cm³) for the first and second ethylene copolymers, based on the deconvoluted relative amounts of first and second ethylene copolymer components in the polyethylene composition, and their estimated resin molecular weight parameters from the above procedure.

A component (or composition) density model was used according to the following equations to calculate the density of the first and second ethylene polymers:

density=0.979863−0.00594808*(FTIRSCB/10000)^{0.65}−0.000383133*[Log₁₀(Mₙ)]³−0.00000577986*(M_{w}/Mₙ)³+0.00557395*(M_{z}/M_{w})^{0.25};

To improve the deconvolution accuracy on the estimation of the short chain branching content (SCB) for the first and second ethylene copolymer components, these estimates ae adjusted to improve the fit between the experimentally measured density and the estimated density of the overall composition according to the following relationship:

(1/density)=Sum(wi/density(i))

where the experimentally measured overall density was used on the left side of the equation, while the estimated density and estimated weight fraction for each component appear on the right side of the equation. The estimation for the short chain branching content (SCB) for the first and second ethylene copolymer components were adjusted to change the calculated overall density of the composition until the fitting criteria were met.

A component (or composition) density model and a component (or composition) melt index, I₂, model was used according to the following equations to calculate the density and melt index I₂ of the first and second ethylene polymers:

density=0.979863−0.00594808*(FTIRSCB/10000)^{0.65}−0.000383133*[Log₁₀(Mₙ)]³−0.00000577986*(M_{w}/Mₙ)³+0.00557395*(M_{z}/M_{w})⁰²⁵;

Log₁₀(melt index,I₂)=22.326528+0.003467*[Log₁₀(Mₙ)]³−4.322582*Log₁₀(M_{w})−0.180061*[Log₁₀(M_{z})]²+0.026478*[Log₁₀(M_{z})]³

where the Mₙ, M_{w} and M_{z} were the deconvoluted values of the individual ethylene polymer components, as obtained from the results of the above GPC deconvolutions. Hence, these two models were used to estimate the melt indexes and the densities of the components (i.e. the first and second ethylene copolymers).

Plaques molded from the polyethylene compositions were tested according to the following ASTM methods: Bent Strip Environmental Stress Crack Resistance (ESCR) at Condition B at 10% IGEPAL at 50° C., ASTM D1693; Flexural Properties, ASTM D 790; Tensile properties, ASTM D 638.

Rotomolding trials were carried out using lab-scale equipment (FERRY RS-160 using test cube). Resins' composition was modified to provide adequate resin stabilization by melt compounding.

Dynamic mechanical analyses were carried out with a rheometer, namely Rheometrics Dynamic Spectrometer (RDS-II) or Rheometrics SR5 or ATS Stresstech, on compression molded samples under nitrogen atmosphere at 190° C., using 25 mm diameter cone and plate geometry. The oscillatory shear experiments were done within the linear viscoelastic range of strain (10% strain) at frequencies from 0.05 to 100 rad/s. The values of storage modulus (G′), loss modulus (G″), complex modulus (G*) and complex viscosity (η*) were obtained as a function of frequency. The same rheological data can also be obtained by using a 25 mm diameter parallel plate geometry at 190° C. under nitrogen atmosphere. The SHI(1,100) value is calculated according to the methods described in U.S. Pat. No. 8,044,160 and U.S. Patent Appl. No. 2008/0287608.

Examples of the polyethylene compositions were produced in a dual reactor solution polymerization process in which the contents of the first reactor flow into the second reactor. This in-series “dual reactor” process produces an “in-situ” polyethylene blend (i.e. the polyethylene composition). Note, that when an in-series reactor configuration is used, un-reacted ethylene monomer, and un-reacted alpha-olefin comonomer present in the first reactor will flow into the downstream second reactor for further polymerization.

In the present inventive examples, although no co-monomer is feed directly to the downstream second reactor, an ethylene copolymer is nevertheless formed in second reactor due to the significant presence of un-reacted 1-octene flowing from the first reactor to the second reactor where it is copolymerized with ethylene. Each reactor is sufficiently agitated to give conditions in which components are well mixed. For examples 9 and 10, the volume of the first reactor was 12 liters and the volume of the second reactor was 22 liters. These are the pilot plant scales. The first reactor was operated at a pressure of 10,500 to 35,000 kPa and the second reactor was operated at a lower pressure to facilitate continuous flow from the first reactor to the second. The solvent employed was methylpentane. The process operates using continuous feed streams. The catalyst employed in the dual reactor solution process experiments was a titanium complex having a phosphinimine ligand, a cyclopentadienide ligand and two activatable ligands, such as but not limited to chloride ligands. A boron based co-catalyst was used in approximately stoichiometric amounts relative to the titanium complex. Commercially available methylaluminoxane (MAO) was included as a scavenger at an Al:Ti of about 40:1. In addition, 2,6-di-tert-butylhydroxy-4-ethylbenzene was added to scavenge free trimethylaluminum within the MAO in a ratio of Al:OH of about 0.5:1.

Examples 1 to 6 were manufactured using a commercial scale facility (dual reactor solution phase, single-site catalyst).

Examples 7 and 8 are commercial rotomolding grades manufactured on a gas-phase reactor.

The polymerization conditions used to make the inventive compositions are provided in Table 1.

Inventive and comparative polyethylene composition properties are described in Table 2.

Calculated properties for the first ethylene copolymer and the second ethylene copolymer for selected comparative and inventive polyethylene compositions, as obtained from GPC-FTIR deconvolution studies, are provided in Table 3.

The properties of pressed plaques made from comparative and inventive polyethylene compositions are provided in Table 4.

Rheological properties of inventive and comparative examples are described in Table 5.

Examples 9 and 10 correspond to Inventive examples 1 and 3 of U.S. Pat. No. 8,962,755, respectively.

Inventive polyethylene compositions (Inventive Examples 3, 9 and 10) are made using a single site phosphinimine catalyst in a dual reactor solution process as described above and have an ESCR at condition B10 of greater than 20 hours and a SCB1/SCB2 ratio of greater than 0.50. These inventive examples also have a M_{z} values of less than 400,000.

As can be seen from the data provided in Tables 3 and 4, the Inventive polyethylene compositions (Inventive Examples 3, 9 and 10) which have a ratio of short chain branching SCB1/SCB2 of greater than 0.5, have improved ESCR B properties while maintaining good processability.

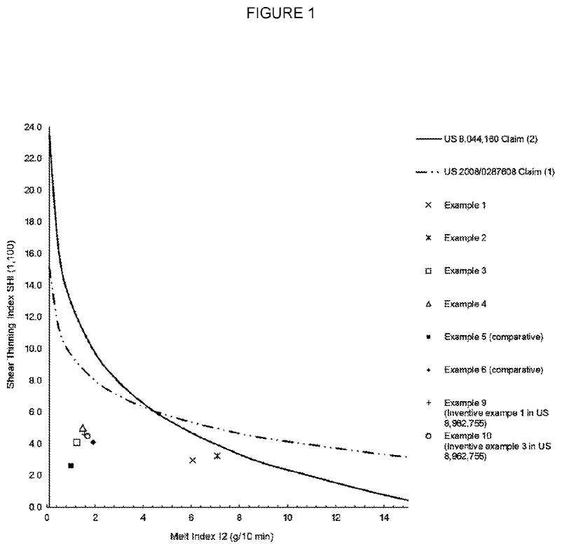

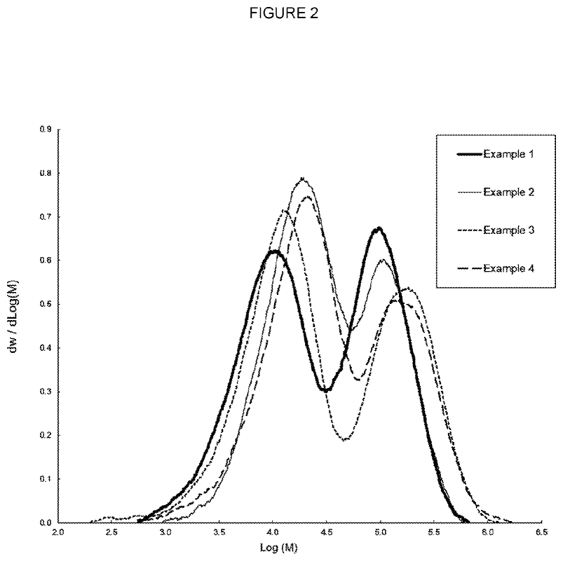

As shown in FIG. 1, the polyethylene compositions described by examples 1 to 10 do not satisfy the equation SHI_{(1,100)}≥−10.58 (log I₂ of the polyethylene composition in g/10 min)/(g/10 min)+12.94, which is a property of the blends taught in U.S. Pat. No. 8,044,160. As shown in FIG. 1, the polyethylene compositions described by examples 1 to 10 do not satisfy the equation: SHI_{(1,100)}≥−5.5 (log I₂ of the polyethylene composition in g/10 min)/(g/10 min)+9.66, which is a property of the blends taught in U.S. Patent Appl. No. 2008/0287608.

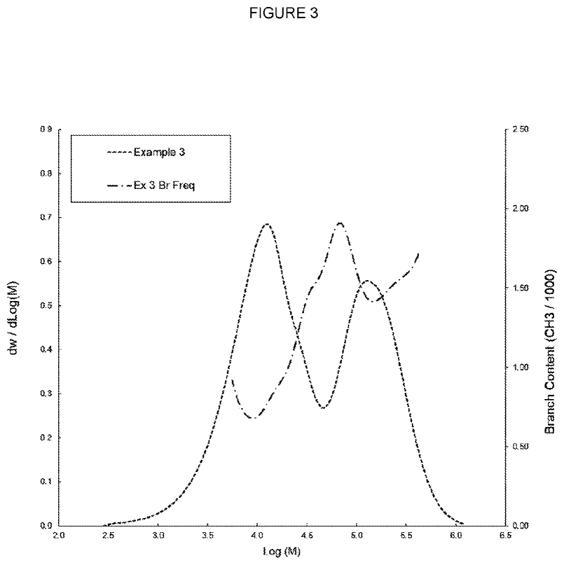

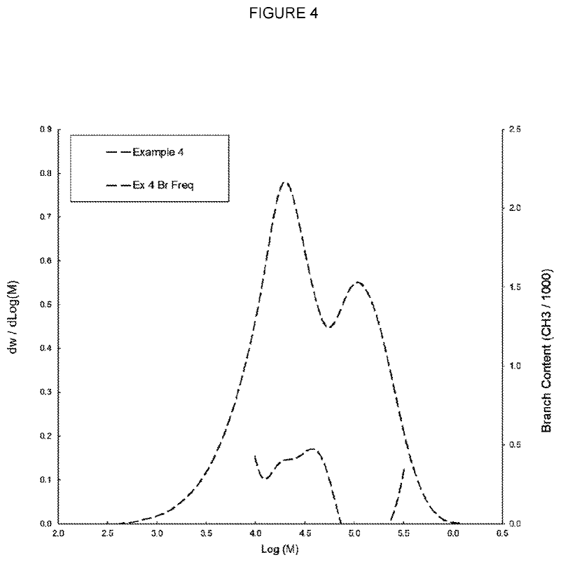

Examples 5, 6, 7, and 8 have characteristics of polyethylene compositions commonly used in commercial rotomolding applications. Useful references outlining desirable characteristics of a rotational molding resin have described in the literature (Crawford and Throne, 2002; Bellehumeur et al., 1998). Examples 1, 2, 3 and 4 all show many characteristics that fall outside these guidelines. The molecular weight distribution is relatively broad with a polydispersity index >3.5 (GPC) and different comparable to that seen with conventional commercial rotomolding grades (Table 2, FIGS. 3 and 4). Narrow molecular weight distributions and uniform comonomer distributions are usually associated with rheological characteristics favorable for powder densification.

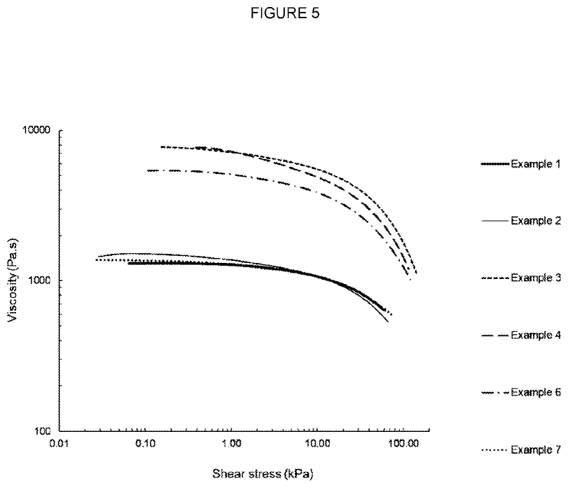

The zero-shear viscosity and viscosity profile of the inventive examples is within a range commonly seen in rotomolding applications (Table 5 and FIG. 5). The relative elasticity of some inventive examples comparable to that observed with commercial rotomolding grades (Table 5). This is surprising given that the inventive examples have a much broader molecular weight distribution. The relative elasticity is evaluated based on the value of storage modulus G′ at a value G″ (loss modulus) of 500 Pa, from DMA frequency sweep measurements. A low value is indicative of a low relative elasticity and is favorable for the powder densification during the rotational molding process. The evaluation of relative elasticity is based on measurements carried out at low frequencies, which are most relevant for conditions associated with powder sintering and densification in rotomolding. The value of G′ at G″=500 Pa corresponds to low frequencies that are representative of that expected during powder densification.

Alternatively, the relative elasticity can be evaluated as the ratio of G′ over G″ at a set frequency of 0.05 rad/s, from measurements carried out using dynamic mechanical analysis at 190° C. Data reported in the literature show that resin compositions with a relative elasticity tend to exhibit processing difficulties in terms of slow powder densification. Wang and Kontopoulou (2004) reported adequate rotomoldability for blend compositions that were characterized with a relative elasticity as high as 0.125. In that study, the effect of plastomer content on the rotomoldability of polypropylene was investigated (W. Q. Wang and M. Kontopoulou (2004) Polymer Engineering and Science, Vol. 44, no 9, pp 1662-1669). Further analysis of the results published by Wang and Kontopoulou show that compositions with higher plastomer content exhibited increasing relative elasticity (G′/G″>0.13) and correspondingly increasing difficulties in achieving full densification during rotomolding evaluation.

Examples 5, 6, 7 and 8 are representative of conventional compositions used in rotomolding applications. The relative elasticity of examples 1 and 3 is comparable to that of examples 5, 6, 7 and 8. This is surprising given the broad molecular weight distributions of examples 1 and 3.

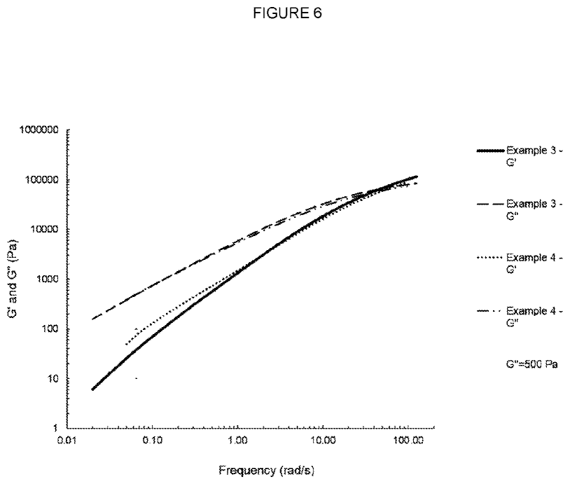

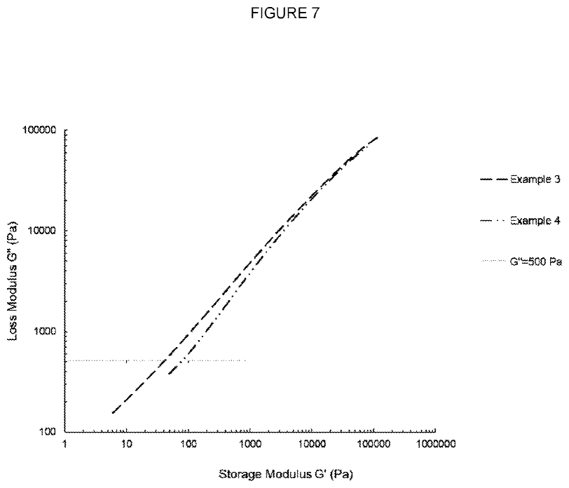

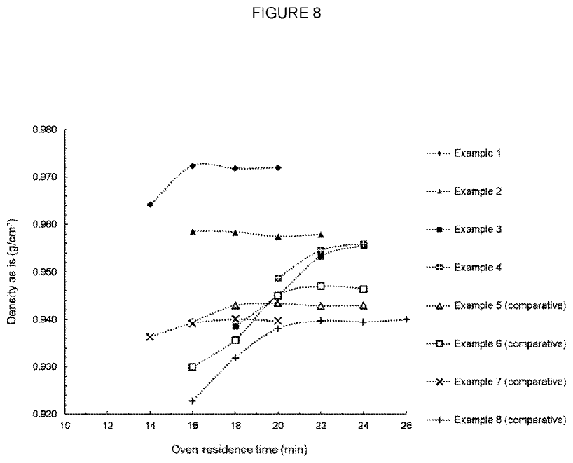

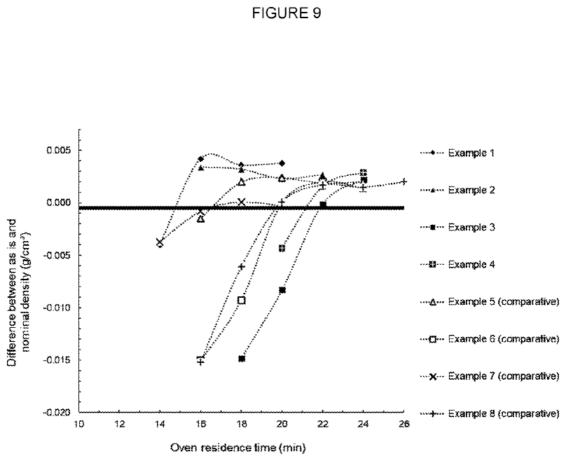

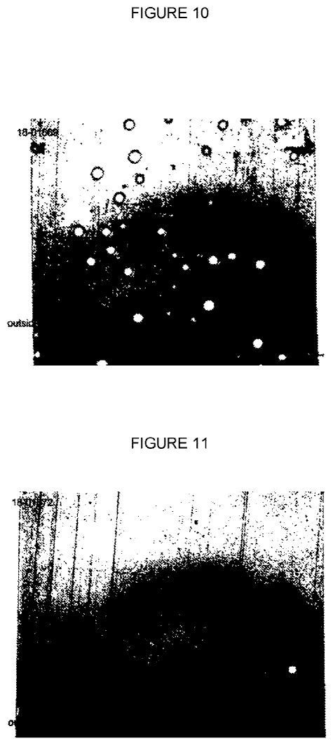

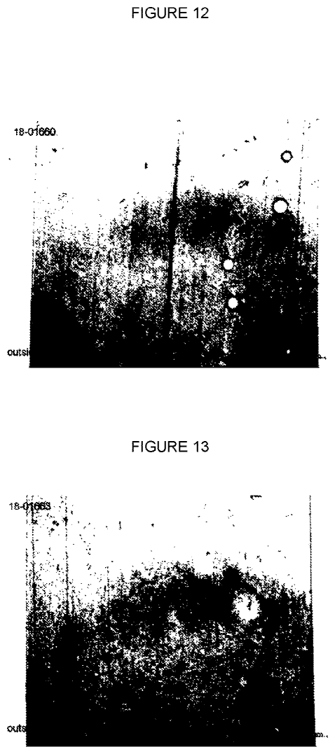

We see that the relative elasticity of example 4 is much higher to that of example 3, despite example 3 having a narrower molecular weight distribution (FIGS. 6 and 7). Example 4 is characterized by having a less homogeneous comonomer distribution (CDBI value) compared to CCs154. We speculate that at low frequencies, inhomogeneities other than the molecular weight distribution might become important on the relative elasticity of the material. Despite having a higher relative elasticity, example 4 displays a good densification behavior (FIGS. 8 to 13).

The melt strength was measured by capillary rheometry. The values for melt strength are relatively high for examples 3 and 4, compared to that obtained using examples 6, 7, 8. Melt strength is important is some applications where molded part thickness is small relative to the size of the part itself. Melt strength helps minimize the occurrence of secondary melt flow inside the mold cavity which then results in uneven part thickness. Melt strength is also advantageous for foaming applications. The challenge in designing resin with high melt strength is to maintain the relative elasticity to a range that allows for adequate powder densification.

The inventive examples exhibit higher onset of melting temperature and melting peaks when compared to commercial rotomolding grades used as comparative examples (from DSC, Table 1). This is expected given that the inventive examples have a higher density. It is relevant to rotomolding as higher values for softening point, melting point and heat of fusion will cause some delays for the completion of powder melting and densification during the heating cycle of the process. However, results from rotomolding trials did not show substantial shift in the densification profiles, when factoring differences in rheological characteristics.

The inventive examples advantageously exhibit one or more mechanical performance characteristics. Inventive examples have tensile and flexural properties that are substantially higher than that provided by commercial rotomolding grades (Table 2). The inventive examples also show a complete powder densification to form rotomolded parts that are free or nearly free of bubbles. It is not unusual in commercial rotomolding application to stop the heating cycle at a point when a very small number of bubbles remain near the inside surface of the molded part. The powder densification for such parts is usually considered adequate and completed. The examples demonstrate that densification is complete by comparison between the resin nominal density and the density as-is (density measured on a specimen collected from a molded part).

TABLE 1
Reactor Conditions

| | Example 1 | Example 2 | Example 3 | Example 6 |
|---|---|---|---|---|
| Ethylene split between first reactor | 0.50/0.50 | 0.45/0.55 | 0.45/0.55 | 0.35/0.65 |
| (R1), second reactor (R2) | | | | |
| Octene split between first Reactor | 0/0 | 1/0 | 1/0 | 1/0 |
| (R1) and second reactor (R2), and | | | | |
| third reactor (R3) | | | | |
| Octene to ethylene ratio in fresh | 0.000 | 0.019 | 0.035 | 0.059 |
| feed | | | | |
| Hydrogen in reactor 1 (ppm) | 2.7 | 2.6 | 1.2 | 1.1 |
| Hydrogen in reactor 2 (ppm) | 31.5 | 21.7 | 28.5 | 7.6 |
| Reactor 1 temperature (° C.) | 163.0 | 162 | 136.0 | 139.0 |
| Reactor 2 temperature (° C.) | 190.8 | 196 | 190.0 | 206.0 |
| Reactor 1 ethylene conversion (%) | 92.5 | 92.0 | 91.0 | 89.0 |
| Reactor 2 ethylene conversion (%) | 82.3 | 88.0 | 84.0 | 88.0 |

| | Example 9 | Example 10 |
|---|---|---|
| Ethylene split between first reactor | 0.50/0.50 | 0.45/0.55 |
| (R1), second reactor (R2) | | |
| Octene split between first Reactor | 0/0 | 1/0 |
| (R1) and second reactor (R2), and | | |
| third reactor (R3) | | |
| Octene to ethylene ratio in fresh | 0.000 | 0.019 |
| feed | | |
| Hydrogen in reactor 1 (ppm) | 2.7 | 2.6 |
| Hydrogen in reactor 2 (ppm) | 31.5 | 21.7 |
| Reactor 1 temperature (° C.) | 163.0 | 162 |
| Reactor 2 temperature (° C.) | 190.8 | 196 |
| Reactor 1 ethylene conversion (%) | 92.5 | 92.0 |
| Reactor 2 ethylene conversion (%) | 82.3 | 88.0 |

TABLE 2
Resin Characteristics

| | Example 1 | Example 2 | Example 3 | Example 4 | Example 5 |
|---|---|---|---|---|---|
| Density (g/cm³) | 0.9682 | 0.9552 | 0.9534 | 0.9540 | 0.9424 |
| Melt Index I₂ (g/10 min) | 6.05 | 7.08 | 1.2 | 1.5 | 4.0 |
| I6 MI (g/10 min) | 24.0 | 29.4 | 5.33 | 6.59 | 15.1 |
| I21 MI (g/min) | 184 | 240 | 68.8 | 72 | 90.8 |
| I21/I2 | 30.5 | 33.9 | 56.0 | 46.4 | 22.9 |
| Stress Exponent | 1.26 | 1.30 | 1.34 | 1.35 | 1.26 |
| Branch Freq/1000C (FTIR) | | 1.6 | 2.4 | 1.8 | 3.5 |
| Comonomer ID | Homo- | octene | octene | octene | octene |
| | polymer | | | | |
| Comonomer mol % | 0 | 0.3 | 0.5 | 0.4 | 0.7 |
| Comonomer wt % | 0 | 1.2 | 1.9 | 1.4 | 2.7 |
| Unsat internal/1000C (FTIR) | | 0.004 | 0.002 | 0.015 | 0.014 |
| Side Chain Unsat/100C | | 0.001 | 0.001 | 0.002 | 0.001 |
| Unsat terminal/1000C (FTIR) | | 0.009 | 0.009 | 0.01 | 0.01 |
| Unsat total/1000C (FTIR) | | 0.014 | 0.01 | 0.03 | 0.025 |
| Onset melting peak (DSC) (° C.) | 124.6 | 124.4 | 122.2 | 123.0 | 120.2 |
| Melting point (DSC) (° C.)) | 133.2 | 129.9 | 128.7 | 130.2 | 126.1 |
| Heat of fusion (J/g) | 243.4 | 218.1 | 221.9 | 210.1 | 182.5 |
| Crystallinity (%) | 83.9 | 75.2 | 76.5 | 72.5 | 62.9 |
| Mₙ (GPC) | 10,627 | 17,660 | 10,375 | 16,209 | 30,037 |
| M_{w} (GPC) | 63,133 | 65,199 | 94,834 | 96,731 | 72,159 |
| M_{z} (GPC) | 159,999 | 158,389 | 283,975 | 299,601 | 150,459 |
| Polydispersity Index (M_{w}/Mₙ) | 5.9 | 3.7 | 9.1 | 6.0 | 2.4 |
| Index (M_{z}/M_{w}) | 2.5 | 2.4 | 3.0 | 3.1 | 2.1 |
| C-TREF CDBI (50) | | 75.3 | 71.6 | 61.8 | |
| | Example 6 | Example 7 | Example 8 | Example 9 | Example 10 |
| Density (g/cm³) | 0.9441 | 0.9408 | 0.9384 | 0.9529 | 0.9524 |
| Melt Index I₂ (g/10 min) | 1.9 | 6.6 | 3.7 | 1.57 | 1.69 |
| I6 MI (g/10 min) | 8.25 | 25.9 | 14.6 | 7.1 | 7.7 |
| I21 MI (g/min) | 68.7 | 156 | 88 | 90 | 104 |
| I21/I2 | 35.8 | 23.5 | 23.7 | 58.0 | 61.0 |
| Stress Exponent | 1.33 | 1.24 | 1.25 | 1.38 | 1.38 |
| Branch Freg/1000C (FTIR) | 2.8 | 5.4 | 6.1 | 3.0 | 3.0 |
| Comonomer ID | octene | Hexene | hexene | octene | octene |
| Comonomer mol % | 0.6 | 1.1 | 1.2 | 0.6 | 0.6 |
| Comonomer wt % | 2.2 | 3.2 | 3.6 | | |
| Unsat internal/1000C (FTIR) | 0.12 | 0.001 | 0 | 0.003 | 0.002 |
| Side Chain Unsat/100C | 0 | 0.001 | 0 | 0 | 0 |
| Unsat terminal/1000C (FTIR) | 0.08 | 0.015 | 0.016 | 0.006 | 0.007 |
| Unsat total/1000C (FTIR) | 0.20 | 0.017 | 0.016 | 0.009 | 0.009 |
| Onset melting peak (DSC) (° C.) | 121.0 | 122.3 | 121.9 | | |
| Melting point (DSC) (° C.)) | 127.5 | 127.3 | 126.4 | 127.3 | 127.5 |
| Heat of fusion (J/g) | 196.0 | 189.1 | 173.9 | 203.8 | 207.3 |
| Crystallinity (%) | 67.6 | 65.2 | 60.0 | 70.3 | 71.5 |
| Mₙ (GPC) | 28,756 | 25,692 | 27,473 | 10,524 | 10,579 |
| M_{w} (GPC) | 92,251 | 69,741 | 79,560 | 83,712 | 86,319 |
| M_{z} (GPC) | 256,978 | 166,490 | 189,761 | 256,210 | 291,056 |
| Polydispersity Index (M_{w}/Mₙ) | 3.2 | 2.7 | 2.9 | 7.95 | 8.16 |
| Index (M_{z}/M_{w}) | 2.8 | 2.4 | 2.4 | 3.1 | 3.4 |
| C-TREF CDBI (50) | 88.8 | 42.2 | 49.0 | 81.8 | 80.4 |

TABLE 3
Characteristics of Components

| | Example 1 | Example 2 | Example 3 | Example 4 | Example 6 |
|---|---|---|---|---|---|
| 1st ETHYLENE POLYMER | | | | | |
| (High Mw - Deconvolution Studies) | | | | | |
| Weight fraction (%) | 0.529 | 0.454 | 0.451 | 0.438 | 0.305 |
| Mₙ | 52,700 | 58,600 | 92,300 | 87,500 | 95,500 |
| M_{w} | 105,400 | 117,200 | 184,600 | 175,000 | 191,000 |
| M_{z} | 158,100 | 175,800 | 276,900 | 262,500 | 286,500 |
| Polydispersity Index (M_{w}/Mₙ) | 2.0 | 2.0 | 2.0 | 0.5 | 2.0 |
| Branch Freg/1000C (SCB1) | 0.0 | 0.30 | 1.20 | 0.02 | 2.00 |
| Density estimate (g/cm³) (d1) | 0.9457 | 0.9417 | 0.9324 | 0.9393 | 0.9293 |
| Melt Index I₂ estimate (g/10 min) | 0.68 | 0.46 | 0.08 | 0.10 | 0.07 |
| 2nd ETHYLENE POLYMER | | | | | |
| (Low Mw - Deconvolution Studies) | | | | | |
| Weight fraction (%) | 0.471 | 0.546 | 0.549 | 0.562 | 0.695 |
| Mₙ | 4,900 | 8,900 | 6,300 | 9,800 | 18,600 |
| M_{w} | 9,800 | 17,800 | 12,600 | 19,600 | 40,400 |
| M_{z} | 14,700 | 26,700 | 18,900 | 29,400 | 70,300 |
| Polydispersity Index (M_{w}/Mₙ) | 2.0 | 2.0 | 2.1 | 2.0 | 2.2 |
| Branch Freg/1000C (SCB2) | 0.0 | 0.10 | 0.40 | 0.30 | 0.10 |
| Density estimate (g/cm³) (d2) | 0.9667 | 0.9611 | 0.9617 | 0.9589 | 0.9551 |
| Melt Index I₂ estimate (g/10 min) | 10,904 | 862 | 3,718 | 576 | 29 |

TABLE 4
Plaque Properties

| | Example 1 | Example 2 | Example 3 | Example 4 | Example 5 |
|---|---|---|---|---|---|
| Flexural Secant Modulus 1% (MPa) | | 1316 | 1337 | 1340 | 1008 |
| Flex Sec Mod 1% Deviation (MPa) | | 55 | 23 | 49 | 14 |
| Tensile Yield Strength (MPa) | 33.8 | 29.0 | 29.0 | 27.5 | 21.8 |
| Tensile Yield Strength Deviation (MPa) | 0.6 | 0.6 | 0.1 | 0.2 | 0.4 |
| Tensile Ultimate Strength (MPa) | 33.8 | 20.5 | 33.2 | 28.5 | 32.0 |
| Tensile Ultimate Strength Deviation (MPa) | 0.6 | 3.9 | 3.3 | 2.2 | 1.6 |
| Tensile Secant Modulus 1% (MPa) | 2206 | 1372 | 1357 | 1189 | 1159 |
| Tensile Sec Mod 1% Deviation (MPa) | 69 | 56 | 18 | 86 | 127 |
| ESCR Cond. B at 100% (hours) | 3 | 16 | >1000 | | |
| ESCR Cond. B at 10% (hours) | | 5 | 176 | 19 | 20 |
| | Example 6 | Example 7 | Example 8 | Example 9 | Example 10 |
| Flexural Secant Modulus 1% (MPa) | 1005 | 897 | 783 | 1274 | 1267 |
| Flex Sec Mod 1% Deviation (MPa) | 20 | 19 | 27 | 39 | 19 |
| Tensile Yield Strength (MPa) | 23.2 | 21.7 | 19.1 | 26 | 26.4 |
| Tensile Yield Strength Deviation (MPa) | 0.1 | 0.1 | 0.2 | 0.2 | 0.3 |
| Tensile Ultimate Strength (MPa) | 29.4 | 14.1 | 16.3 | 21.8 | 24.7 |
| Tensile Ultimate Strength Deviation (MPa) | 4.1 | 0.1 | 0.9 | 6.8 | 7.4 |
| Tensile Secant Modulus 1% (MPa) | 1115 | 909.8 | 979 | 1483 | 1331 |
| Tensile Sec Mod 1% Deviation (MPa) | 197 | 17.1 | 149 | 121 | 241 |
| ESCR Cond. B at 100% (hours) | >1000 | 30 | >1000 | | |
| ESCR Cond. B at 10% (hours) | 95 | 7 | 194 | 309 | 212 |

TABLE 5
Rheological Properties

| | Example 1 | Example 2 | Example 3 | Example 4 | Example 5 |
|---|---|---|---|---|---|
| Zero Shear Viscosity - 190° C. (Pa · s) | 1329 | 1538 | 7701 | 8002 | 2504 |
| DMA Freq: G′ at G″ = 500 Pa at 190° C. (Pa) | 23 | 44 | 40 | 76 | 55 |
| Relative Elasticity G′/G″ at 0.05 rad/s | 0.010 | 0.039 | 0.068 | 0.129 | 0.031 |
| DMA Freq: Viscosity Ratio (η_{0.5}/η₅₀) | 1.23 | 1.91 | 3.40 | 1.91 | 1.44 |
| Capillary Melt Strength (cN) | 0.48 | 0.51 | 2.22 | 1.99 | 0.92 |
| Capillary Melt Strength Stretch Ratio | 1570 | 1376 | 603 | 724 | 1064 |
| Shear Thinning Index SHI (1,100) | 3.0 | 3.3 | 4.1 | 5.0 | 2.6 |
| | Example 6 | Example 7 | Example 8 | Example 9 | Example 10 |
| Zero Shear Viscosity - 190° C. (Pa · s) | 5531 | 1383 | 2597 | 6328 | 6184 |
| DMA Freq: G′ at G″ = 500 Pa at 190° C. (Pa) | 41 | 27 | 27 | 45 | 42 |
| Relative Elasticity G′/G″ at 0.05 rad/s | 0.057 | 0.020 | 0.024 | 0.071 | 0.060 |
| DMA Freq: Viscosity Ratio (η_{0.5}/η₅₀) | 3.06 | 1.69 | 1.96 | | |
| Capillary Melt Strength (cN) | 1.55 | 0.52 | 0.85 | | |
| Capillary Melt Strength Stretch Ratio | 940 | 1766 | 1176 | | |
| Shear Thinning Index SHI (1,100) | 4.1 | 2.7 | 2.5 | 4.6 | 4.5 |

### Rotomolding

In general, the process comprises charging the bimodal polyethylene composition of claim 1 into a mold, heating this mold in an oven to above 280° C., such that the stabilized polyolefin fuses, rotating the mold around at least 2 axes, the plastic material spreading to the walls, cooling the mold while still rotating, opening it, and taking the resultant hollow article out.

### INDUSTRIAL APPLICABILITY

A bimodal polyethylene is suitable for the production of rotomolded articles.

1. A rotomolded part prepared from a bimodal polyethylene composition comprising:
(1) 10 to 70 wt % of a first ethylene copolymer having a melt index I₂, of less than 1.0 g/10 min; a molecular weight distribution M_{w}/Mₙ, of less than 3.0; and a density of from 0.920 to 0.955 g/cm³; and
(2) 90 to 30 wt % of a second ethylene copolymer having a melt index I₂, of from 100 to 20,000 g/10 min; a molecular weight distribution M_{w}/Mₙ, of less than 3.0; and a density higher than the density of said first ethylene copolymer, but less than 0.967 g/cm³;
wherein the density of said second ethylene copolymer is less than 0.037 g/cm³ higher than the density of said first ethylene copolymer; the ratio (SCB1/SCB2) of the number of short chain branches per thousand carbon atoms in said first ethylene copolymer (SCB1) to the number of short chain branches per thousand carbon atoms in said second ethylene copolymer (SCB2) is greater than 0.5; and wherein said bimodal polyethylene composition has a molecular weight distribution M_{w}/Mₙ, of from 3 to 11; a density of at least 0.949 g/cm³; a melt index I₂, of from 0.4 to 8.0 g/10 min; an M_{z} of less than 400,000; a stress exponent of less than 1.50; and a relative elasticity defined as the ratio of G′/G″ at frequency of 0.05 rad/s, less than 1.3.

2. The rotomolded part of claim 1 wherein the ratio (SCB1/SCB2) of the number of short chain branches per thousand carbon atoms in said first ethylene copolymer (SCB1) to the number of short chain branches per thousand carbon atoms in said second ethylene copolymer (SCB2) is at least 1.0.

3. The rotomolded part of claim 1 wherein the ratio (SCB1/SCB2) of the number of short chain branches per thousand carbon atoms in said first ethylene copolymer (SCB1) to the number of short chain branches per thousand carbon atoms in said second ethylene copolymer (SCB2) is at least 1.5.

4. The rotomolded part of claim 1 wherein said bimodal polyethylene composition has an ESCR Condition B (10% IGEPAL) of at least 60 hours.

5. The rotomolded part of claim 1 wherein said bimodal polyethylene composition has an ESCR Condition B (10% IGEPAL) of at least 120 hours.

6. The rotomolded part of claim 1 wherein said bimodal polyethylene composition has a molecular weight distribution, M_{w}/Mₙ, of from 4.5 to 9.5.

7. The rotomolded part of claim 1 wherein said bimodal polyethylene composition has melt index I₂, of from 0.4 to 3.0 g/10 min.

8. The rotomolded part of claim 1 wherein said first ethylene copolymer has a density of from 0.925 to 0.950 g/cm³.

9. The rotomolded part of claim 1 wherein said second ethylene copolymer has a density of less than 0.965 g/cm³.

10. The rotomolded part of claim 1 wherein said bimodal polyethylene composition has a density of from 0.951 to 0.957 g/cm³.

11. The rotomolded part of claim 1 wherein the density of said second ethylene copolymer is less than 0.031 g/cm³ higher than the density of said first ethylene copolymer.

12. The rotomolded part of claim 1 wherein said second ethylene copolymer has a melt index I₂, of greater than 1,500 g/10 min.

13. The rotomolded part of claim 1 wherein said first and second ethylene copolymers have a M_{w}/Mₙ of less than 2.5.

14. The rotomolded part of claim 1 wherein said bimodal polyethylene composition has a comonomer distribution breadth index (CDBI) of greater than 65%.

15. The rotomolded part of claim 1 wherein said bimodal polyethylene composition comprises:
from 30 to 60 wt % of said first ethylene copolymer; and
from 70 to 40 wt % of said second ethylene copolymer.

16. The rotomolded part of claim 1 wherein said bimodal polyethylene composition has a comonomer content of less than 0.75 mol % as determined by ¹³C NMR.

17. The rotomolded part of claim 1 wherein the bimodal polyethylene composition further comprises a nucleating agent.

18. The rotomolded part of claim 1 wherein said first and second ethylene copolymers are copolymers of ethylene and 1-octene.

19. The rotomolded part of claim 1 wherein said bimodal polyethylene composition is prepared by contacting ethylene and an alpha-olefin with a polymerization catalyst under solution polymerization conditions in a least two polymerization reactors.

20. The rotomolded part of claim 1 wherein said bimodal polyethylene composition contains an additive package comprising:
5) a hindered monophosphite;
6) a diphosphite;
7) a hindered amine light stabilizer; and
8) at least one additional additive selected from the group consisting of a hindered phenol and a hydroxylamine.

21. A process for the production of polyolefin hollow articles, which comprises charging the bimodal polyethylene composition of claim 1 into a mold, heating this mold in an oven to above 280° C., such that the stabilized polyolefin fuses, rotating the mold around at least 2 axes, the plastic material spreading to the walls, cooling the mold while still rotating, opening it, and taking the resultant hollow article out.
